(19) United States
(12) Patent Application Publication
(10) Pub. No.: US 2026/0268711 A1
(43) Pub. Date: Sep. 10, 2026

(54) Spoof-Resistant Facial Recognition Through Illumination and Imaging Engineering

(71) Applicant: Metalenz, Inc., Boston, MA (US)

(72) Inventors: Robert C. Devlin, Stoneham, MA (US); Xiangdong Wang, Carlisle, MA (US)

(73) Assignee: Metalenz, Inc., Boston, MA (US)

(21) Appl. No.: 19/656,849

(22) Filed: Apr. 23, 2026

Related U.S. Application Data
(63) Continuation of application No. 18/067,640, filed on Dec. 16, 2022, now Pat. No. 12,639,983.
(60) Provisional application No. 63/265,617, filed on Dec. 17, 2021.

(51) Int. Cl. G06V 40/40; G01J 4/00; G06V 10/141; G06V 10/74

(52) U.S. Cl. CPC G06V 40/40; G01J 4/00; G06V 10/141; G06V 10/761; G06V 2201/07

(57) ABSTRACT

Disclosed herein systems and methods of performing spoof resistant object recognition. In certain embodiments, a system for object recognition includes: an illumination device configured to illuminate an object; a sensor device, wherein the sensor device receives illumination light reflected off the object which includes polarization information; a processor; memory including programming executable by the processor to: calculate the polarization information from the illumination light; use the polarization information to determine whether the object is a real 3D object. It has been discovered that polarization information may be utilized to determine whether an object is a 3D object or a flat (2D) object. Thus, the polarization information may be utilized to differentiate from an image of a 3D object and a photograph of an object.

### CROSS-REFERENCE TO RELATED APPLICATIONS

The current application is a continuation of U.S. patent application Ser. No. 18/067,640, entitled “Spoof-Resistant Facial Recognition Through Illumination and Imaging Engineering”, filed Dec. 16, 2022 and published as US 2023-0196842 A1 on Jun. 22, 2023, which claims the benefit of and priority under 35 U.S.C. § 119 (e) to U.S. Provisional Patent Application Ser. No. 63/265,617, entitled “Spoof-Resistant Facial Recognition Through Illumination and Imaging Engineering,” filed Dec. 17, 2021, the disclosures of which are incorporated herein by reference in their entireties for all purposes.

### FIELD OF THE INVENTION

The present invention generally relates to spoof resistant object recognition utilizing polarization.

### BACKGROUND

Metasurface elements are diffractive optical elements in which individual waveguide elements have subwavelength spacing and have a planar profile. Metasurface elements have recently been developed for application in the UV-IR bands (300-10,000 nm). Compared to traditional refractive optics, metasurface elements abruptly introduce phase shifts onto light field. This enables metasurface elements to have thicknesses on the order of the wavelength of light at which they are designed to operate, whereas traditional refractive surfaces have thicknesses that are 10-100 times (or more) larger than the wavelength of light at which they are designed to operate. Additionally, metasurface elements have no variation in thickness in the constituent elements and thus are able to shape light without any curvature, as is required for refractive optics. Compared to traditional diffractive optical elements (DOEs), for example binary diffractive optics, metasurface elements have the ability to impart a range of phase shifts on an incident light field, at a minimum the metasurface elements can have phase shifts between 0-2π with at least 5 distinct values from that range, whereas binary DOEs are only able to impart two distinct values of phase shift and are often limited to phase shifts of either 0 or 1π. Compared to multi-level DOE's, metasurface elements do not require height variation of its constituent elements along the optical axis, only the in-plane geometries of the metasurface element features vary. Metasurface elements may be utilized in polarization sensing devices.

### SUMMARY OF THE DISCLOSURE

Systems and methods in accordance with various embodiments of the invention can include a system for object recognition including: an illumination device configured to illuminate an object; a sensor device, where the sensor device receives illumination light reflected off the object which includes polarization information; a processor; memory including programming executable by the processor to: calculate the polarization information from the illumination light; use the polarization information to determine whether the object is a real 3D object.

In various other embodiments, the sensor device and/or the illumination device comprise one or more metasurface optical elements.

In still various other embodiments, the memory further includes programming that is configured to use the polarization information to determine whether the object is a real 3D object or whether the object is a picture of an object, a mask of a 3D object, or a video of a 3D object.

In still various other embodiments, the polarization information includes at least one selected from the group consisting of: an S₁ polarization, an S₂ polarization, an S₃ polarization, a degree of polarization (DoP), and an azimuth.

In still various other embodiments, the S₁ polarization, the S₂ polarization, the S₃ polarization is defined as:

$${S}_{0} = I ;$$

$${S}_{1} = Ip cos 2 ψ cos 2 χ ;$$

$${S}_{2} = Ip sin 2 ψ cos 2 χ ; and$$

$${S}_{3} = Ip sin 2 χ ,$$

where the S₀ polarization corresponds to an original monochromic image.

In still various other embodiments, the DoP is calculated by

$$D o P = \frac{\sqrt{{S}_{1}^{2} + {S}_{2}^{2} + {S}_{3}^{2}}}{{S}_{0}} .$$

In still various other embodiments, the memory further includes programming programming executable by the processor to compare an original optical image of the object to a subsequent optical image of the object to perform object recognition.

In still various other embodiments, the original optical image and the subsequent optical image are 2D near infrared images.

In still various other embodiments, the original optical image and the subsequent optical image are polarization images.

In still various other embodiments, the memory further includes programming executable by the processor to determine whether portions of the original optical image and/or the subsequent optical image are not real, where comparing the original optical image to the subsequent optical image of the object is not performed on the portions of the original optical image and/or the subsequent optical image determined to be not real.

In still various other embodiments, the portions of the original optical image and/or the subsequent optical image that are not real are of a mask, sunglasses, and/or a beard.

In still various other embodiments, determining whether portions of the original optical image and/or the subsequent optical image are not real is performed based on the polarization information from the illumination light.

In still various other embodiments, the object includes a face.

In still various other embodiments, the memory further includes programming that is configured to perform an object detection algorithm.

In still various other embodiments, the memory further includes programming that is configured to utilize the results from the object detection algorithm to separate out object pixels from non-object pixels.

In still various other embodiments, the sensor device further receives an initial image and a subsequent image, and the memory further includes programming that is configured to compare the initial image with the subsequent image to determine whether the initial image and the subsequent image are substantially the same.

In still various other embodiments, comparing the initial image with the subsequent image is only performed on the object pixels of the subsequent image.

In still various other embodiments, the illumination source includes an LED or VCSEL array.

In still various other embodiments, the illumination source further includes sunlight.

In still various other embodiments, the system further includes an ambient light sensor configured to determine the amount of sunlight, where the memory further includes programming executable by the processor to alter the amount of light outputted by the LED or VCSEL array based on the amount of sunlight.

In still various other embodiments, the system further includes a bandpass filter configured to pass a certain wavelength of light from the sunlight.

In still various other embodiments, the illumination source includes sunlight.

Further, systems and methods in accordance with various embodiments of the invention can include a method for verifying object recognition, the method including: illuminating an object with a source of light; sensing the light reflected off the object for polarization information; and determining, using the polarization information, whether the object is a real 3D object.

In various other embodiments, illuminating the object is performed by an illumination device, sensing the light reflected off the object is performed by a sensor device, and where the sensor device and/or the illumination device include one or more metasurface elements.

In still various other embodiments, the method further includes using the polarization information to determine whether the object is a real 3D object or whether the object is a picture of an object, a mask of a 3D object, or a video of a 3D object.

In still various other embodiments, the polarization information includes at least one selected from the group consisting of: an S₁ polarization, an S₂ polarization, an S₃ polarization, a degree of polarization (DoP), and an azimuth.

In still various other embodiments, the S₁ polarization, the S₂ polarization, the S₃ polarization is defined as:

$${S}_{0} = I ;$$

$${S}_{1} = Ip cos 2 ψ cos 2 χ ;$$

$${S}_{2} = Ip sin 2 ψ cos 2 χ ; and$$

$${S}_{3} = Ip sin 2 χ ,$$

where the S₀ polarization corresponds to an original monochromic image.

In still various other embodiments, the DoP is calculated by

$$DoP = \frac{\sqrt{{S}_{1}^{2} + {S}_{2}^{2} + {S}_{3}^{2}}}{{S}_{0}} .$$

In still various other embodiments, the method further includes comparing an original optical image of the object to a subsequent optical image of the object to perform object recognition.

In still various other embodiments, comparing the original optical image to the subsequent optical image is performed before the determining whether the object is a real 3D object.

In still various other embodiments, comparing the original optical image to the subsequent optical image is performed after the determining whether the object is a real 3D object.

In still various other embodiments, the method further includes determining whether portions of the original optical image and/or the subsequent optical image are not real, where comparing the original optical image to the subsequent optical image of the object is not performed on the portions of the original optical image and/or the subsequent optical image determined to be not real.

In still various other embodiments, the portions of the original optical image and/or the subsequent optical image that are not real are of a mask, sunglasses, and/or a beard.

In still various other embodiments, determining whether portions of the original optical image and/or the subsequent optical image are not real is performed based on the polarization information from the illumination light.

In still various other embodiments, the object includes a face.

In still various other embodiments, the method further includes performing an object detection algorithm.

In still various other embodiments, the method further includes utilizing the results from the object detection algorithm to separate out object pixels from non-object pixels.

In still various other embodiments, the method further includes receiving an initial image and a subsequent image, and comparing the initial image with the subsequent image to determine whether the initial image and the subsequent image are substantially the same.

In still various other embodiments, comparing the initial image with the subsequent image is only performed on the object pixels of the subsequent image.

In still various other embodiments, the source of light includes an LED or VCSEL array.

In still various other embodiments, the source of light further includes sunlight.

In still various other embodiments, the method further including determining the amount of sunlight and altering the amount of light outputted by the LED or VCSEL array based on the amount of sunlight.

In still various other embodiments, the method further includes filtering out a certain wavelength of light from the sunlight.

In still various other embodiments, the source of light includes sunlight.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. The description will be more fully understood with reference to the following figures, which are presented as exemplary embodiments of the invention and should not be construed as a complete recitation of the scope of the invention, wherein:

FIGS. 1A and 1B are various flow charts describing methods utilizing polarization state of the reflected light to validate a facial recognition in accordance with embodiments of the invention.

FIG. 2A illustrates a method of object recognition utilizing polarization states including a preliminary object detection in accordance with an embodiment of the invention.

FIG. 2B illustrates a method of object recognition utilizing polarization states including a preliminary object detection in accordance with an embodiment of the invention.

FIG. 3 is a block diagram of a computing system which validates a facial recognition in accordance with an embodiment of the invention.

FIG. 4A illustrates an example polarization image capture module in accordance with an embodiment of the invention.

FIG. 4B is various SEM images including different polarization metasurfaces in accordance with an embodiment of the invention.

FIG. 5 illustrates a comparison between a real 2D image of an individual and a 2D image of a picture of an individual in accordance with an embodiment of the invention.

FIG. 6 illustrates a comparison between a real 2D image of an individual, a 2D image of a picture of an individual, and a 2D image of a 3D mask of an individual.

### DETAILED DESCRIPTION

In many examples, two-dimensional facial recognition algorithms include taking a first 2D photo of an individual that is verified to be a real person and then comparing this 2D photo to subsequent photos of an individual to key features from the original (e.g., distance between the eyes, mouth shape, etc.). The comparison may be performed through a machine learning algorithm. If the two images are substantially the same, the system will validate the authenticity of the individual and in the case of a security system, provide the individual access. These facial recognition algorithms may be implemented in smart devices such as a smartphone. Because these systems may function on 2D information alone, such systems are susceptible to being tricked or spoofed through various techniques such as a non-authentic individual holding up a high resolution print out of the authentic individual or, in cases where the 2D system also looks for movement of the person to verify identity, playing back a video of the authentic individual.

In contrast, 3D authentication systems which include a supplemental technology, such as structured light or time of flight, in addition to the 2D image aim to verify with additional information such as the depth of an individual's features. In such a case the system may become robust to attacks with a simple 2D likeness of the authentic individual. These 3D systems can still be susceptible to sophisticated attacks with masks that have the likeness of the authentic individual. These 3D systems may also add inherent complexity, cost, and size compared to their 2D counterparts. In some embodiments, the 3D system may be added in addition to the 2D imaging system.

Various embodiments of the present disclosure include a system that only utilizes 2D information but remains robust to attacks that typically trick or spoof the simple 2D facial recognition system described above. Some embodiments of the presently disclosed system make use of an imaging and illumination system that is able to completely and uniquely identify the polarization state of reflected light from a scene. By analyzing just the 2D image and/or the corresponding polarization state parameters of the image, the system may be robust to spoofs such as 2D photos, videos, and 3D masks. In general, the disclosed invention works as described through the flow chart in the figures described below.

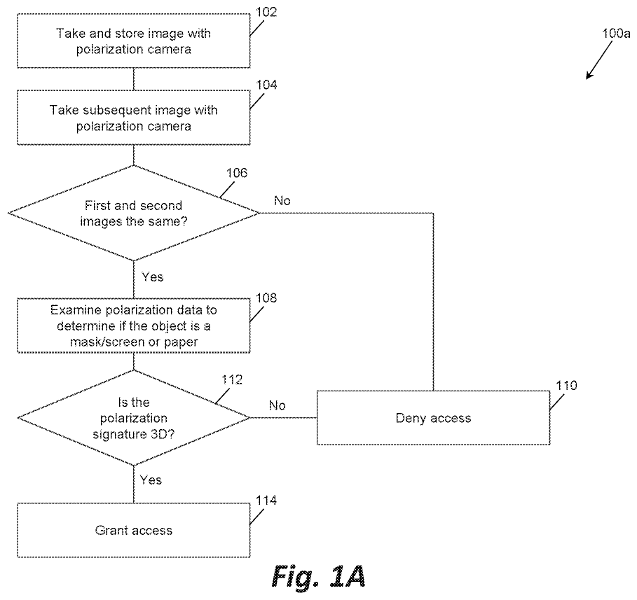

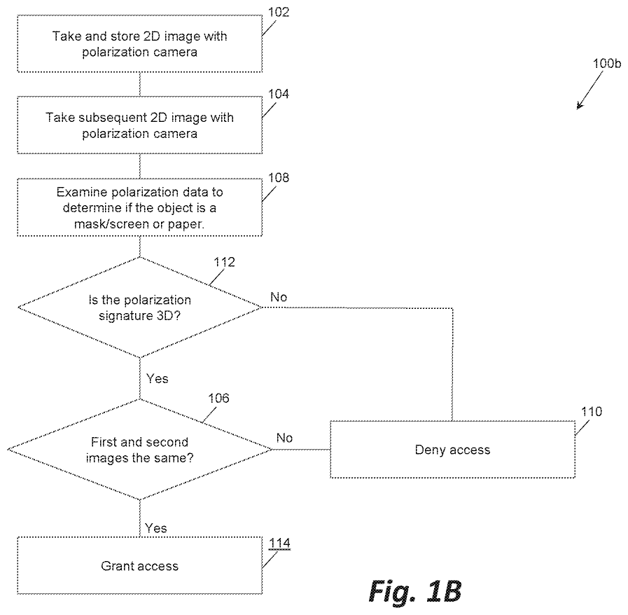

FIGS. 1A and 1B are various flow charts describing methods utilizing the polarization state parameters of the reflected light to validate a facial recognition in accordance with embodiments of the invention. These methods may be performed by a system including a polarization camera, and in some embodiments by a polarization camera which utilizes a metasurface to produce the polarization state images.

FIG. 1A is a flow chart of a method 100a of object recognition utilizing polarization states in accordance with an embodiment of the invention. In FIG. 1A, the method 100a includes taking (102) a first image (e.g. an initial image) including a polarization of a scene, face, or object. In some embodiments, the polarization of the first image may be utilized similar to block 112 to determine whether the first image is “real.” If the first image is not determined to be “real” then the method may prompt the user to take another first image. The method 100a further includes taking (104) a subsequent image of the same scene, face, or object at a later time. The first image and/or the subsequent image may be a set of images close in time—e.g. the same scene or object with one or more images taken in less than 1 second, less than 5 seconds, or less than 10 seconds. In some embodiments, the first image and/or the subsequent image is taken followed closely by a polarization image, or multiple snapshots of the same imaging close in time. In some embodiments, the first image and the subsequent image may be from a 2D near infrared (NIR) photo/camera image (e.g. for intensity, etc.) in conjunction with separate polar images. However, in some embodiments, the first image and the subsequent image may be polarization images (e.g. without the 2D NIR images). Thus, the subsequent image may be utilized in block 112 to determine whether the scene, face, or object is a 3D scene, face, or object without taking another polarization image. In subsequent steps, the polarization images may be compared to verify the authenticity of an object. The method 100a further includes comparing (106) the first image and the subsequent image to see if they are substantially the same. In some embodiments, the comparison is with 2D images or polarization images comparison when utilizing a polarization image for the first image and the subsequent image. In some embodiments, the first image may be a first polarization image and the subsequent image may also be a polarization image and if they are compared and found to be the same, then other polarization images may be utilized to determine whether the first image and the subsequent image are of a real 3D object. If the images are not the same, the system denies (110) the user access. If the images are the same, the system then examines 112 the captured polarization information to ensure the object is a real object and not a 2D photo, 2D video, 2D mask, and/or a person wearing a mask. This may include assessing the texture, depth and/or other “real” parameters, and/or the relative intensity of pixels or portions of images in the polarization images. In some embodiments, examining 112 the captured polarization information to ensure the object is a real object includes analyzing parameters, metrics, and/or benchmarks to determine that the image is “real” 3D image. For example, the polarization information and/or 2D image may be analyzed to determine whether the object has the right texture or polarization parameters. If the polarization information confirms that the object is a 3D object then access is granted. In some embodiments, the object may be a face or person. The method 100a may perform facial recognition.

FIG. 1B is a flow chart of a method 100b of object recognition utilizing polarization states in accordance with an embodiment of the invention. FIG. 1B shares many of the steps of FIG. 1A. The description of these steps is applicable to the method of FIG. 1B and will not be repeated in detail. In FIG. 1B, the method 100b includes first examining (112) the polarization information to see if the image is of a genuine 3D object before proceeding to compare (106) the two images.

In some embodiments, the method of object recognition may include a preliminary object detection before comparing the two images. The object detection may crop pixels that are not part of the object which may make the rest of the steps more accurate and reduce processing time.

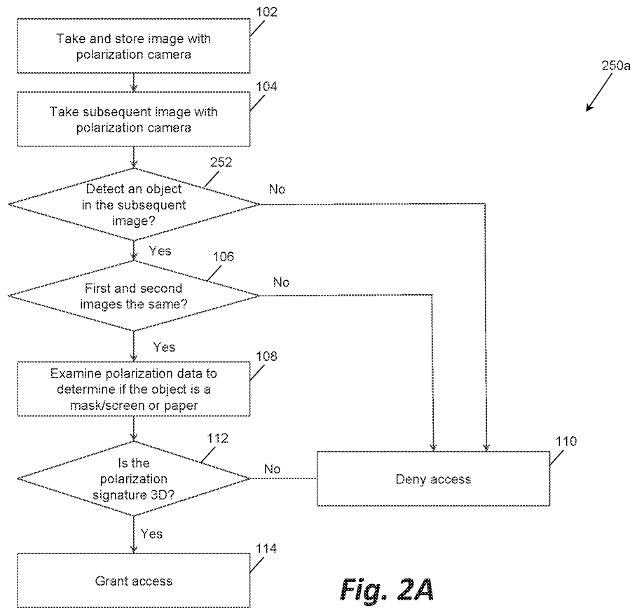

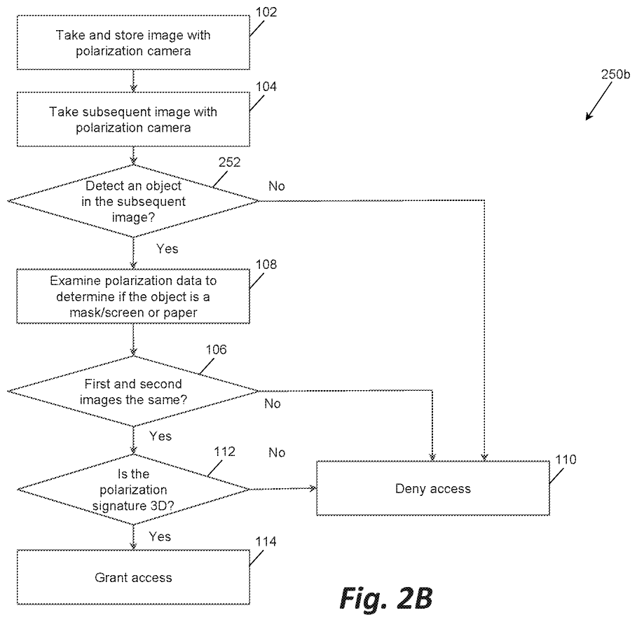

FIG. 2A illustrates a method 250a of object recognition utilizing polarization states including a preliminary object detection in accordance with an embodiment of the invention. FIG. 2A shares many of the steps of FIGS. 1A and 1B. The description of these steps is applicable to the method of FIG. 2A and will not be repeated in detail. In FIG. 2A, the method 250a includes detecting (252) an object in the subsequent image before performing the comparing 106 of the first and second images. The object detection may be a facial detection algorithm. Examples of object detection algorithms are described in Liu, Wei, et al. “Ssd: Single shot multibox detector.” European conference on computer vision. Springer, Cham, 2016 which is hereby incorporated by reference in its entirety.

FIG. 2B illustrates a method 250b of object recognition utilizing polarization states including a preliminary object detection in accordance with an embodiment of the invention. FIG. 2B shares many of the steps of FIGS. 1A and 1B. The description of these steps is applicable to the method of FIG. 2B and will not be repeated in detail. FIG. 2B is similar to FIG. 2A except that the polarization information is examined 112 to see if the image is of a genuine 3D object before proceeding to compare 106 the two images. While the object detection 252 is illustrated and described before the image comparing 106 and the polarization information examining 112, in some embodiments, the object detection 252 may be performed after these two steps as well. The object detection 252 may be used to separate pixels which belong to the object from pixels which do not belong to the object (e.g. non-object pixels) which may make the rest of the steps more accurate and reduce processing time.

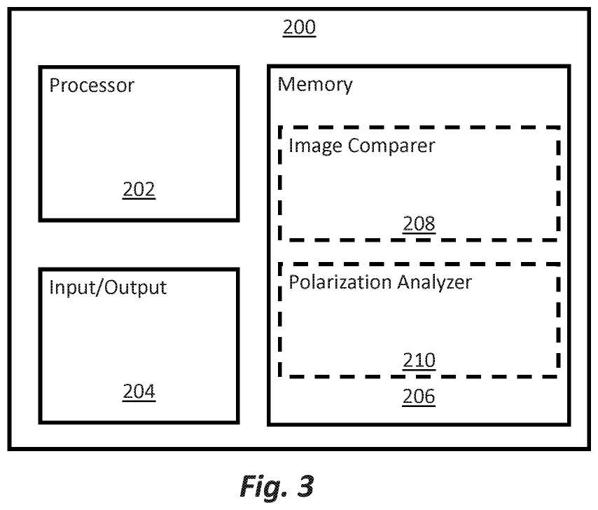

FIG. 3 is a block diagram of a computing system which validates a facial recognition in accordance with an embodiment of the invention. The system 200 may be a separate computing system or a system implemented on the device capturing the 2D images such as a smartphone. The system 200 includes an input/output 204 which is capable of receiving 2D images including polarization. The system 200 further includes a processor 202 and memory 206. The memory 206 includes programming including a 2D image comparer 208 and a polarization analyzer 210 which is executable by the processor. The image comparer 208 may compare the initial 2D image with the later captured 2D image as discussed above. The polarization analyzer 210 may analyze the polarization of a captured polarization of the later captured 2D image to determine whether the polarization signature is consistent with a 3D object. The image comparer 208 and the polarization analyzer 210 may be used to validate facial recognition as discussed in connection with FIGS. 1A, 1B, 2A, 2B. The input/output 204 may output the results of the validation. The memory 206 may further include programming including a object recognizer (not shown) which is configured to perform the object recognition step 252 of FIGS. 2A and 2B.

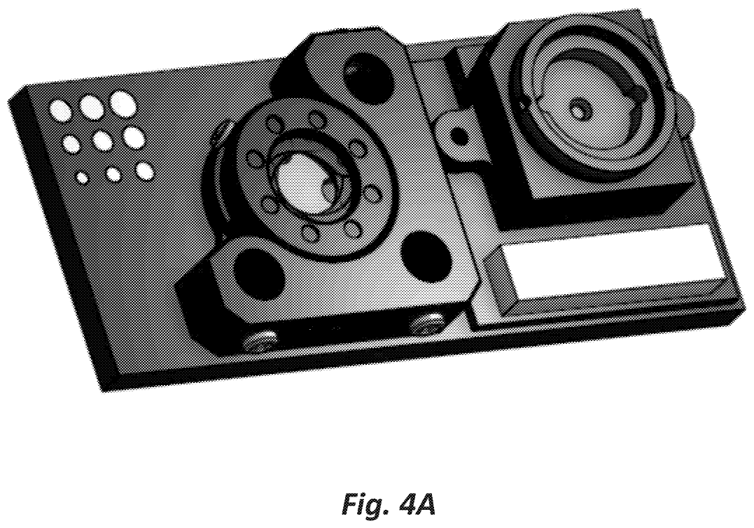

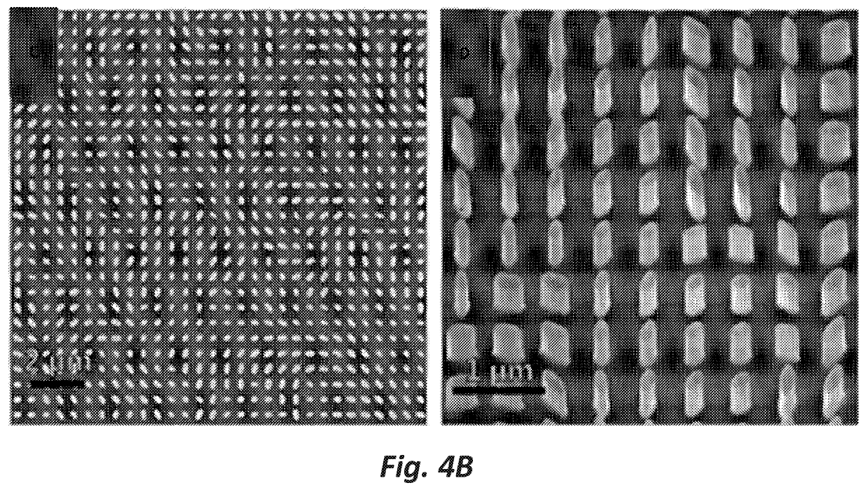

In certain embodiments the imaging system includes both an active illumination source and an imaging sensor or camera. The illumination source may be an illumination device and the imaging sensor or camera may be a sensor device. FIG. 4A illustrates an example polarization image capture module in accordance with an embodiment of the invention. The module includes an active illumination source and a camera which can resolve polarization. In certain embodiments, the camera may resolve the full stokes vector in a single frame. In some embodiments the camera includes one or more metasurfaces configured to produce one or more polarization images with different polarization states. The illumination source may be a light source such as an LED, VCSEL array, or any illumination source that provides a known lighting condition that can be turned on and off.

While the polarization image capture module of FIG. 4A includes an active illumination source, the illumination source may also be sunlight, ambient light or may be sunlight or ambient light supplemented with a light source such as an LED or VCSEL array. The sunlight or ambient light may have a random polarization state in it and also includes a range of wavelengths (e.g. 940 nm and/or typical IR wavelengths). An ambient light sensor may be utilized to turn on or off the light source, or alter the intensity or pattern of the light source, depending on the sunlight/ambient conditions (e.g. the amount of sunlight present). For example, the device may just use sunlight in certain conditions, or use both the light source and sunlight in some conditions. The device may alter the amount of light from the light source dependent on the sunlight conditions. A bandpass filter may be included to filter the wavelengths of the sunlight to only pass one wavelength or a narrow band of wavelengths.

The illumination source can be either preferentially-polarized or unpolarized. In certain embodiments, the light source may be unpolarized or have variable polarization, while in other embodiments the light source may have a fixed polarization state. For example, the light source may be a VCSEL array with a fixed VCSEL polarization. The fixed VCSEL polarization may be achieved through a patterned metasurface aperture on the VCSEL array to achieve a uniform polarization state out of the VCSEL array. In some embodiments, a light source with a fixed polarization state may provide better results than a light source without a polarization. The fixed polarization state may be a linear polarization of light, a circularly polarized light, and/or an elliptically polarized light or any combination of these polarizations of light.

In some embodiments, the illumination source may switch between two or more polarizations in a time resolved method or where it puts out multiple different polarizations in the field of interest. For example, either alternating polarization states may be presented at different times, or two polar states may be presented at the same time. The two polarization states may be orthogonal to each other, or non-orthogonal, and they may be any of two or more of linear, circular or elliptical states. The polarizations may be presented with different patterns of the polarization states, such as for example, flood, dot pattern, batwing pattern, top hat pattern, super-gaussian pattern or other illumination patterns. In some embodiments one or more metasurfaces may be used to produce the various polarization illumination patterns, either simultaneously or alternating, and/or overlapping or physically separated, and/or with different patterns.

In some embodiments, the illumination source and/or the camera may include metasurfaces. Examples of illumination sources and cameras including metasurfaces are described in U.S. Pat. Pub. No. 2019/0064532, entitled “TRANSMISSIVE METASURFACE LENS INTEGRATION” and filed Aug. 31, 2018, which is hereby incorporated by reference in its entirety for all purposes. As described in this Patent Publication, the illumination source and the camera may be included functionally in a single unit. FIG. 4A illustrates an implementation of an illumination source and a camera integrated into a single unit.

In some embodiments, the imaging system may be any imaging system capable of recovering the full polarization information. However, in a more specific case the imaging system may include one or more metasurface optical elements, standard refractive lenses, and a standard CMOS image sensor. The one or more metasurface optical elements may split the scene into two or more polarization states and form two or more sub-images on the CMOS sensor and when these images are suitably computationally recombined, can provide the polarization state of the object being imaged. The imaging system may be a full-stokes polarization camera. An example of a full-stokes polarization camera which incorporates one or more metasurface optical elements is discussed in Rubin N A, D'Aversa G, Chevalier P, Shi Z, Chen W T, Capasso F. Matrix Fourier optics enables a compact full-Stokes polarization camera. Science. 2019 Jul. 5; 365(6448):eaax1839. doi: 10.1126/science.aax1839. PMID: 31273096 which is hereby incorporated by reference in its entirety.

FIG. 4B is various SEM images of an example of polarization metasurface which may be incorporated into the polarization image capture module of FIG. 4A. Further examples of polarization metasurfaces are illustrated in U.S. Pat. Pub. No. 20210286188, entitled “Arbitrary polarization-switchable metasurfaces” and filed Feb. 22, 2019, which is hereby incorporated by reference in its entirety. The polarization metasurface may include silicon posts of one or more shapes including rectangles, squares, and/or ovals in various configurations. The polarization metasurfaces may be in an asymmetric configuration.

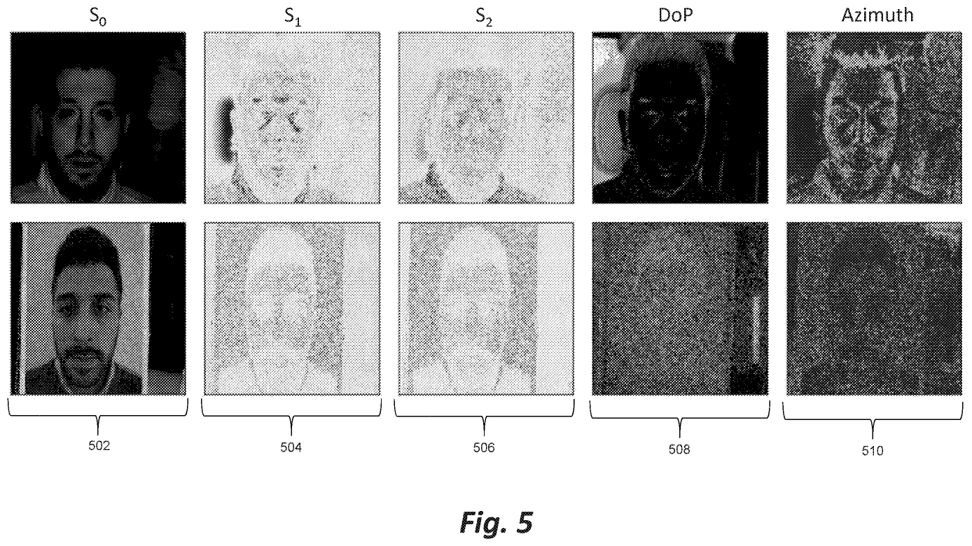

FIG. 5 illustrates a comparison between a real 2D image of an individual and a 2D image of a picture of an individual in accordance with an embodiment of the invention. The real 2D image and the 2D image of the picture may be taken with the polarization imaging system described in connection with FIG. 4A. An S₀ column 502 is the unfiltered black and white image. The S₁ column 504 and S₂ column 506 correspond to different stokes parameters. In some embodiments, the polarization imaging system may also image the Ss parameter which may be used to validate the facial recognition. In some embodiments the S₁ polarization parameter, S₂ polarization parameter, and S₃ polarization parameter may be used in combination to assess whether an object is a 2D object or 3D object. The stokes parameters are defined as the following:

$${S}_{0} = I$$

$${S}_{1} = Ip cos 2 ψ cos 2 χ$$

$${S}_{2} = Ip sin 2 ψ cos 2 χ$$

$${S}_{3} = Ip sin 2 χ$$

where Ip, 2ψ, 2_{χ} are the spherical coordinates of the three-dimensional vector of cartesian coordinates (S₁, S₂, S₃), I is the total intensity of the beam, and p is the degree of polarization, constrained by 0≤p≤1. The S₀ polarization may correspond to an original monochromic image. Further description of the stokes parameters may be found in Young, G., Chipman, R. A., Lam, W. S. T. (2018). Polarized Light and Optical Systems. United Kingdom: CRC Presswhich is hereby incorporated by reference in its entirety for all purposes.

In some embodiments, degree of polarization (DoP) may be used to assess whether an object is a 2D object or 3D object. A DoP column 508 in FIG. 3 corresponds to the portion of each portion of the image that is polarized. The DoP may be calculated through the following formula:

$$DoP = \frac{\sqrt{{S}_{1}^{2} + {S}_{2}^{2} + {S}_{3}^{2}}}{{S}_{0}} .$$

A DoP of 1 is completely polarized light. A DoP of 0 is unpolarized light. A DoP between 0 and 1 is partially polarized light. An example of the definition of DoP may be found at <//www.fiberoptics4sale.com/blogs/wave-optics/102492742-stokes-polarization-parameters> which is hereby incorporated by reference in its entirety for all purposes.

An azimuth column 510 corresponds to the angle between the different polarizations S₁, S₂, and S₃. The azimuth between S₁ and S₂, for example, may be calculated using the following equation:

$$Azimuth = arctan \frac{{S}_{2}}{{S}_{1}} .$$

In some embodiments, linear polarizations including two orthogonal polarizations may be used to validate facial recognition or identify a false object or image, i.e. an intended spoof object or image. For instance, the S₁ image may be an image filtered for p-polarization and the S₂ image may be an image filtered for s-polarization. Non-orthogonal polarizations may also be used. The multiple different polarization states and their polarization parameters may be used to disambiguate or distinguish between a real or natural 3D object and a fake or spoofed object, and/or to recognize or match faces or objects at two different times. The multiple different polarization states and their polarization parameters may also be used to determine the exact likeness of a face and/or the texture or naturalness of skin or surface textures. Any one or more of the different polarization state parameters can be used individually or in combination. In some embodiments, these different polarization state parameters can be used with algorithmic or machine learning to determine the identity of the image and/or face.

Turning back to FIG. 5, the top images are of a real 2D image of an individual which includes a standard monochrome intensity. In comparison, the bottom images are of a photo of an individual. As illustrated, the contrast between each of the S₁, S₂, DoP, and/or the Azimuth may be used to determine whether an image is an image of a real 3D shape which corresponds to a real individual or an image of a photo of an individual which would have less contrast. In some embodiments, a combination of the S₁, S₂, DoP, and/or the Azimuth may be used to determine whether an image is an image of a real 3D shape which corresponds to a real individual or an image of a photo of an individual. In some embodiments, the real 2D image of the individual may include more contrast between the high polarization and the lowest polarization for each of the S₁, S₂, DoP, and/or the Azimuth than the 2D image of the photo of the individual. In some embodiments, a machine learning algorithm such as a neural network may be used with training data to determine whether an image is an image of a real 3D shape which corresponds to a real individual or an image of a photo of an individual. As illustrated, the monochromatic images S₀ alone does not show enough information to determine whether the 2D image is of a real 3D individual or of a photo of an individual. In some embodiments, the relative intensity or other metrics of the various polarization state images may be compared on a pixel-by-pixel basis, or by regions, as part of the comparison process, and/or image processing or machine learning algorithms may be applied.

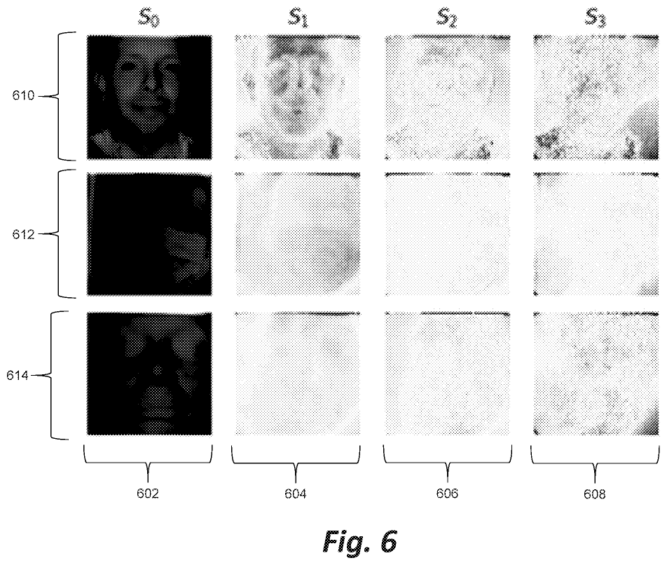

FIG. 6 illustrates a comparison between a real 2D image of an individual, a 2D image of a picture of an individual, and a 2D image of a 3D mask of an individual. The S₀, S₁, S₂, and S₃ columns are described above in connection with FIG. 3. The S₀ column 502, S₁ column 504, and S₂ column of FIG. 5 correspond to an S₀ column 602, an S₁ column 604, and an S₂ column 606 of FIG. 6. FIG. 6 further includes an S₃ column 608 which corresponds to S₃ polarization measurements. As illustrated, the S₃ polarization measurement may be different polarization measurements than the S₁ and S₂ polarization measurements.

The top row 610 of images correspond to a real 2D image of an individual. The middle row 612 of images correspond to a 2D image of a picture of an individual. The bottom row 614 of images correspond to a 2D image of a mask of an individual. As illustrated, the contrast between each of the S₁, S₂, and/or S₃, may be used to determine whether an image is an image of a real 3D shape which corresponds to a real individual or an image of a photo of an individual or an image of a mask of an individual which would have less contrast. In some embodiments, a combination of the S₁, S₂, and/or S₃, may be used to determine whether an image is an image of a real 3D shape which corresponds to a real individual or an image of a photo of an individual or a mask of an individual. As illustrated, the monochromatic images S₀ alone does not show enough information to determine whether the 2D image is of a real 3D individual, of a photo of an individual, or of a mask of an individual.

In some embodiments, a portion of an image is sensed to be “unreal” or “unnatural”. For example, if a person has on a mask (e.g. surgical mask, N95 mask, KN-95 mask, dust mask, cosmetic mask), sunglasses, a beard or the like, especially in comparison to a prior image without such added features, then the system may recognize these features based on the polarization state parameters of that region of the image or images of the face. For example, the texture of the part of the face that is covered by a beard or surgical mask may appear altered or “non-skin-like” based on the differences in polarization parameters, either in comparison to benchmarks or as compared to a prior image or images of the face without the added feature. In some embodiments, the texture aspects sensed via the polarization state parameters of one or more polarization images may be used to identify a feature (e.g., a beard, glasses, mask, etc.), and/or for comparison to a later similar set of images to determine identity or matching, and/or to remove that identified feature from later comparison. For example, if a first set of images of a person's face without a surgical mask are taken using the systems and processes described above, and then the same person's face is similarly imaged but now the face has a surgical mask, then the comparison and analysis of the two sets of images may include identifying the surgical mask, either via comparison and/or texture change. In some cases the first set of images has the added feature of a beard or mask, and the second set of features do not have the added feature, and the system and processes described here may be used to distinguish the added feature. In some cases, the analysis or comparison can continue just comparing the two sets of images in the region without the added mask to determine a match or identity. It should be understood that while examples here of facial features and added features (masks, beards, glasses, etc.) to a face are described as examples, the same concepts, systems and processes may be applied to other body parts or inanimate objects to identify features and/or make comparisons of portions that remain unchanged or uncovered by the added features.

### DOCTRINE OF EQUIVALENTS

While the above description contains many specific embodiments of the invention, these should not be construed as limitations on the scope of the invention, but rather as an example of one embodiment thereof. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A system for object recognition comprising:
an illumination device configured to illuminate an object, wherein the illumination device comprises an LED or VCSEL array;
a sensor device, wherein the sensor device receives illumination light reflected off the object which includes polarization information, wherein the sensor device and/or the illumination device comprise one or more metasurface optical elements;
a processor; and
memory including programming executable by the processor to:
calculate the polarization information from the illumination light; and
use the polarization information to determine whether the object is a real 3D object.

2. The system of claim 1, wherein the memory further includes programming that is configured to use the polarization information to determine whether the object is a real 3D object or whether the object is a picture of an object, a mask of a 3D object, or a video of a 3D object.

3. The system of claim 1, wherein the polarization information includes at least one selected from the group consisting of: an S₁ polarization, an S₂ polarization, an S₃ polarization, a degree of polarization (DoP), and an azimuth.

4. The system of claim 3, wherein the S₁ polarization, the S₂ polarization, the S₃ polarization is defined as:
$${S}_{0} = I ;$$
$${S}_{1} = Ip cos 2 ψ cos 2 χ ;$$
$${S}_{2} = Ip sin 2 ψ cos 2 χ ; and$$
$${S}_{3} = Ip sin 2 χ ,$$
wherein the S₀ polarization corresponds to an original monochromic image.

5. The system of claim 4, wherein the DoP is calculated by
$$DoP = \frac{\sqrt{{S}_{1}^{2} + {S}_{2}^{2} + {S}_{3}^{2}}}{{S}_{0}} .$$

6. The system of claim 1, wherein the memory further includes programming executable by the processor to compare an original optical image of the object to a subsequent optical image of the object to perform object recognition.

7. The system of claim 6, wherein the original optical image and the subsequent optical image are 2D near infrared images.

8. The system of claim 6, wherein the original optical image and the subsequent optical image are polarization images.

9. The system of claim 6, wherein the memory further includes programming executable by the processor to determine whether portions of the original optical image and/or the subsequent optical image are not real, wherein comparing the original optical image to the subsequent optical image of the object is not performed on the portions of the original optical image and/or the subsequent optical image determined to be not real.

10. The system of claim 9, wherein the portions of the original optical image and/or the subsequent optical image that are not real are of a mask, sunglasses, and/or a beard.

11. The system of claim 6, wherein determining whether portions of the original optical image and/or the subsequent optical image are not real is performed based on the polarization information from the illumination light.

12. The system of claim 1, wherein the object comprises a face.

13. The system of claim 1, wherein the memory further includes programming that is configured to perform an object detection algorithm.

14. The system of claim 13, wherein the memory further includes programming that is configured to utilize the results from the object detection algorithm to separate out object pixels from non-object pixels.

15. The system of claim 14 wherein the sensor device further receives an initial image and a subsequent image, and wherein the memory further includes programming that is configured to compare the initial image with the subsequent image to determine whether the initial image and the subsequent image are substantially the same.

16. The system of claim 15, wherein comparing the initial image with the subsequent image is only performed on the object pixels of the subsequent image.

17. The system of claim 1, wherein the illumination device further comprises sunlight.

18. The system of claim 17, further comprises an ambient light sensor configured to determine the amount of sunlight, wherein the memory further includes programming executable by the processor to alter the amount of light outputted by the LED or VCSEL array based on the amount of sunlight.

19. The system of claim 17, further comprising a bandpass filter configured to pass a certain wavelength of light from the sunlight.

20. The system of claim 1, wherein the illumination device comprises sunlight.
